(19) United States
(12) Patent Application Publication
(10) Pub. No.: US 2024/0430608 A1
(43) Pub. Date: Dec. 26, 2024

(54) Clip-On Earphone and Wearing Method Thereof

(71) Applicant: Yuanhao Liu, Shenzhen (CN)

(72) Inventor: Yuanhao Liu, Shenzhen (CN)

(21) Appl. No.: 18/241,901

(22) Filed: Sep. 4, 2023

(30) Foreign Application Priority Data
Jun. 20, 2023 (CN) 2023107398292

(51) Int. Cl. H04R 1/10; H04R 1/06; H04R 25/02

(52) U.S. Cl. CPC H04R 1/105; H04R 1/06; H04R 1/1016; H04R 1/1041; H04R 1/1091; H04R 25/02; H04R 2201/10

(57) ABSTRACT

A clip-on earphone includes a cavum conchae wearing portion which is adapted to be worn at a cavum conchae of an ear of a user, a connecting portion which is adapted to surround the user's helix, and a clamping portion which is adapted to fit on a rear ear side of the user's ear, wherein the cavum conchae wearing portion is connected to the clamping portion through the connecting portion and forms a wearing space, and at least a portion of the user's helix is adapted to be clamped in the wearing space.

### CROSS REFERENCE OF RELATED APPLICATION

This application is a non-provisional application that claims priority under 35U.S.C. § 119 to China application number 202310739829.2, filing date Jun. 20, 2023, wherein the entire content of which is expressly incorporated herein by reference.

### BACKGROUND OF THE PRESENT INVENTION

### Field of Invention

The present invention relates to the field of earphone technology, and particularly to a clip-on earphone and wearing method thereof.

### Description of Related Arts

Earphones have become indispensable products among people's consumer electronic devices, especially in the current era of increasingly population of music players and mobile devices. Earphones are used to receive electrical signals emitted from media players or signal receivers and convert the electrical signals into audio signals for users to hear.

Currently, common types of earphones in the market include in-ear earphone, head-wearing earphone, ear-hook headphone, etc., and each type of earphones has different disadvantages.

Although a size of the in-ear earphone is small and easy to carry, and the earphone that can be inserted into an ear canal is called the in-ear earphone, wearing the in-ear earphone for a long time can cause discomfort and certain hearing disorder of the user. In addition, it is necessary to regularly clean the earphones, otherwise it is easy to breed bacteria and cause ear diseases for the user. The earphone worn on an outer auricle is called semi-in-ear earphone, which is easy to fall off during intensive movements of the user. In addition, in some occasions, due to complete sound insulation that the user is not able to hear the environment noise when wearing the in-ear earphone, it is easy to cause accidents.

The head-wearing earphone is generally having a good acoustic effect and noise insulation performance, as well as is able to provide a strong shock effect, so as to create an immersive hearing experience. However, the conventional head-wearing earphone has a relative large size, which is inconvenient for carrying and storage, and requires more power to drive. The problem of blocking external environment noise also exits, which can easily lead to accidents.

Compared to the head-wearing earphone, the ear-hook headphone has advantages such as good stability, strong privacy, affordable price, and adjustable noise insulation effect. However, the ear-hook headphone also has disadvantages such as poor comfort, inferior sound quality and noise reduction effect. Especially, the ear-hook headphone may interfere with other accessories, affecting the wearing of pair of glasses and other devices such as hearing aids. Moreover, they are difficult to store after use.

More importantly, when the user want to wear earrings, many types of earrings are not compatible with the conventional earphones. In other words, when wearing the conventional earphones, it is impossible to wear earrings at the same time. Even if it is possible to wear the earrings and the earphones at the same time, it is easy to have mutual interference and collision between them ultimately resulting in damage to the earrings or poor audible experience of the user from the earphones.

### SUMMARY OF THE PRESENT INVENTION

The invention is advantageous in that it provides a clip-on earphone and wearing method thereof, wherein the clip-on earphone has a wearing space which is suitable for fitting ear contours of different users, so that the clip-on earphone is securely worn on the user's ear and is not easy to slip off.

Another advantage of the present invention is to provide a clip-on earphone and wearing method thereof, wherein the clip-on earphone has a wearing space which can be adjusted in size during initial wearing, so as to adapt to the ear shapes of different users and fit more closely to the user's ear contour, making it not easy to fall off.

Another advantage of the present invention is to provide a clip-on earphone and wearing method thereof, wherein the clip-on earphone is easy to wear and remove, so as to improve the user's wearing experience.

Another advantage of the present invention is to provide a clip-on earphone and wearing method thereof, wherein the clip-on earphone is designed according to the structure of the human ear, conforming to ergonomic design, so that the clip-on earphone is better held on the user's ear helix, avoiding detachment and not easy to be lost.

Another advantage of the present invention is to provide a clip-on earphone and wearing method thereof, wherein the clip-on earphone can be suitable for the ear shapes of different users, and the wearing population is wide, which is conducive to promotion.

Another advantage of the present invention is to provide a clip-on earphone and wearing method thereof, wherein by an open wearing manner, the clip-on earphone avoids direct insertion into the user's outer ear canal to seal off the outer ear canal which can cause bacterial contamination and ear infections due to unhygienic conditions of the earphone.

Another advantage of the present invention is to provide a clip-on earphone and wearing method thereof, wherein by the open wearing manner, the clip-on earphone avoids hearing disorder caused by long-term wearing and direct insertion into the user's outer ear canal to seal off the outer ear canal.

Another advantage of the present invention is to provide a clip-on earphone and wearing method thereof, wherein by the open wearing manner, the clip-on earphone allows the user to listen to the sound from the earphone while not blocking the external environment noise, thus avoiding safety hazards.

Another advantage of the present invention is to provide a clip-on earphone and wearing method thereof, wherein by the open wearing manner, the clip-on earphone ensures stability and avoids discomfort caused by long-term wearing and pressure on the user's ears.

Another advantage of the present invention is to provide a clip-on earphone and wearing method thereof, wherein the clip-on earphone does not need to be completely inserted into the outer ear canal to seal the outer ear canal, achieving painless wearing and reducing fatigue from long-term listening, thereby enhancing the wearer's use experience.

Another advantage of the present invention is to provide a clip-on earphone and wearing method thereof, wherein the outer surface of the clip-on earphone can be designed with beautiful patterns or inlaid with diamonds, which has good ornamental value and can be used as a decoration.

Another advantage of the present invention is to provide a clip-on earphone and wearing method thereof, wherein the clip-on earphone is compatible with the wearing of earrings without affecting the common use of earrings.

Another advantage of the present invention is to provide a clip-on earphone and wearing method thereof, wherein the clip-on earphone is compatible with the wearing of a hearing-aid, thereby avoiding the inconvenience of the user with hearing impairments that he or she is not able to use the hearing-aid when using the earphone.

Another advantage of the present invention is to provide a clip-on earphone and wearing method thereof, wherein the clip-on earphone can integrate an artificial intelligence module, thereby having strong interactivity and providing convenience for the user's life.

In order to achieve at least one of the above advantages or other advantages and objectives, according to one aspect of the present application, the present invention provides a clip-on earphone, comprising a cavum conchae wearing portion which is adapted to be worn at a cavum conchae of an ear of a user, a connecting portion which is adapted to surround the user's helix, and a clamping portion which is adapted to fit on a rear ear side of the user's ear, wherein the cavum conchae wearing portion is connected to the clamping portion through the connecting portion and forms a wearing space, and at least a portion of the user's helix is adapted to be clamped in the wearing space.

According an embodiment of the present invention, the clip-on earphone is worn on the user, an inner side of the connecting portion is configured to span and fit on the user's helix.

According an embodiment of the present invention, when the clip-on earphone is worn on the user, the cavum conchae wearing portion and the clamping portion are configured to be adjustable relative to each other to fit the user's auricle.

According an embodiment of the present invention, the connecting portion is integrally connected with the cavum conchae wearing portion and the clamping portion, wherein the clamping portion, and at least a portion of the connecting portion and at least a portion of the cavum conchae wearing portion which are connected to the connecting portion are deformable, so as to facilitate adjustment of the wearing space.

According an embodiment of the present invention, a material of the clamping portion, and the portion of the connecting portion and the portion of the cavum conchae wearing portion which are connected to the connecting portion is copper, silver, stainless steel, or precious metal.

According an embodiment of the present invention, the connecting portion is assembled with the cavum conchae wearing portion and the clamping portion, wherein the connecting portion is deformable, and the cavum conchae wearing portion and the clamping portion are deformable or rigid.

According an embodiment of the present invention, a material of the connecting portion is copper, silver, stainless steel, or precious metal.

According an embodiment of the present invention, the connecting portion, the cavum conchae wearing portion, and the clamping portion are mainly made of copper, silver, stainless steel, precious metal, ABS material, PP material, PC material, rubber, or silicone material.

According an embodiment of the present invention, the cavum conchae wearing portion comprises an installation body having an installation space, and an acoustic unit installed in the installation space of the installation body and is suitable for facing an outer ear canal of the user's ear.

According an embodiment of the present invention, the installation body of the cavum conchae wearing portion comprises an installation shell and an installation cover, and the clamping portion comprises a clamping shell and a clamping cover, wherein the connecting portion is connected to the installation shell and the clamping shell, wherein the connecting portion, the installation shell, and the clamping shell are made of a deformable material.

According an embodiment of the present invention, the installation body of the cavum conchae wearing portion comprises an installation shell and an installation cover, the installation cover is suitable for facing an outer ear canal of the user, wherein the clamping portion comprises a middle frame, an inner cover, and an outer cover, wherein the inner cover and the outer cover are connected to opposite sides of the middle frame, wherein the connecting portion, the installation shell, and the middle frame are integrated and made of a deformable material.

According an embodiment of the present invention, the clip-on earphone further comprises one or more decorative elements arranged on at least a portion of a surface of the cavum conchae wearing portion, the connecting portion, and the clamping portion.

According an embodiment of the present invention, the one or more decorative elements are formed on at least a portion of the surface of the cavum conchae wearing portion, the connecting portion, and the clamping portion through inlaying or carving process.

According an embodiment of the present invention, the clip-on earphone further comprises a power unit and a control panel, and at least one of the power unit and the control panel is installed in the clamping portion.

According an embodiment of the present invention, the clip-on earphone further comprises a hearing aid module which is electrically connected to the control panel to integrate the functions of a hearing-aid and an earphone.

According an embodiment of the present invention, the control panel is integrated with a microphone and an artificial intelligence module to enable the clip-on earphone to form a smart voice interaction assistant.

According an embodiment of the present invention, the connecting portion comprises a connecting body and has a wire groove, wherein the said clip-on earphone comprises a set of pow cords disposed in the wire groove which is recessed on an outer surface or an inner surface of the connecting body.

According an embodiment of the present invention, the connecting portion comprises a connecting body and a wire groove, wherein the said clip-on earphone comprises a set of pow cords which is disposed in the wire groove, and the wire groove is located inside the connecting body.

According an embodiment of the present invention, when the clip-on earphone is worn on the user, the cavum conchae wearing portion faces an outer ear canal at an inner side, and an inner side of the clamping portion is inclinedly abutted against the rear ear side of the user's ear.

According an embodiment of the present invention, the clip-on earphone further comprises a pendant element which comprises a hanging string and a pendant, wherein one end of the hanging string is connected to one of the cavum conchae wearing portion, the connecting portion, and the clamping portion, and the other end of the hanging string is connected to the pendant.

According an embodiment of the present invention, the connecting portion further comprises a light emitting element and a light guiding element, wherein the light emitting element is disposed at one end of the connecting body, and the light guiding element is disposed in the wire groove, and when the light emitting element emits light, the light is guided into the light guiding element.

According an embodiment of the present invention, the connecting portion comprises a connecting body, the connecting body comprises a central section and two connecting sections, wherein the central section is located between the two connecting sections, and the central section has a smaller thickness compared to the two connecting sections.

The present invention further provides a method for wearing a clip-on earphone, comprising the following steps.
(a) Configure relative position of a cavum conchae wearing portion and a clamping portion to be adjustable so that a wearing space formed by the cavum conchae wearing portion, the clamping portion, and a connecting portion is capable of being adjusted.
(b) Configure the cavum conchae wearing portion adapted to be worn at a cavum conchae and the clamping portion adapted to be fitted on a rear ear side of the user's ear to clamp at least a portion of the user's helix in the wearing space, so that the cavum conchae wearing portion and the clamping portion are constructed to be clamped on two sides of the user's auricle.

The present invention further provides a method for wearing a clip-on earphone, comprising the following steps.
(A) Configure a wearing space formed by a cavum conchae wearing portion, a clamping portion, and a connecting portion which is adapted to be aligned with a user's helix and allow the clip-on earphone to slide down along the helix from an upper edge of the user's helix.
(B) Configure the cavum conchae wearing portion adapted to be slid down to be worn at a cavum conchae and the clamping portion adapted to be slid down to be fitted on a rear ear side of the user's ear to clamp at least a portion of the user's helix in the wearing space, so that the cavum conchae wearing portion and the clamping portion are constructed to be clamped on two sides of the user's auricle.

According an embodiment of the present invention, the above method further comprises a step of configuring relative position of the cavum conchae wearing portion and the clamping portion is configured to be adjustable so that the wearing space formed by the cavum conchae wearing portion, the clamping portion, and the connecting portion is capable of being adjusted to fit the user's ear.

### BRIEF DESCRIPTION OF THE DRAWINGS

FIG. 1 is a perspective view of a clip-on earphone according to a first preferred embodiment of the present invention.

FIG. 2 is another perspective view of the clip-on earphone according to the above first preferred embodiment of the present invention.

FIG. 3 is another perspective view of the clip-on earphone according to the above first preferred embodiment of the present invention.

FIG. 4A is an exploded view of the clip-on earphone according to the above first preferred embodiment of the present invention.

FIG. 4B is another exploded view of the clip-on earphone according to the above first preferred embodiment of the present invention.

FIG. 5 is a sectional view of the clip-on earphone according to the above first preferred embodiment of the present invention.

FIG. 6 is a perspective view illustrating an application scenario of the clip-on earphone being worn on the user's ear according to the above first preferred embodiment of the present invention.

FIG. 7 is a perspective view illustrating an application scenario of the clip-on earphone being worn on the user's ear in a sliding wearing manner in an initial wearing process according to the above first preferred embodiment of the present invention.

FIG. 8 is a perspective view illustrating an application scenario of the clip-on earphone being worn on the user's ear in a sliding wearing manner after the initial adjusting and wearing process according to the above first preferred embodiment of the present invention.

FIG. 9 is an exploded view of the clip-on earphone according to an alternative mode of the above first preferred embodiment of the present invention.

FIG. 10 is a perspective view of the clip-on earphone according to another alternative mode of the above first preferred embodiment of the present invention.

FIG. 11 is a perspective view of the clip-on earphone according to another alternative mode of the above first preferred embodiment of the present invention.

FIG. 12 is a perspective view of a clip-on earphone according to a second preferred embodiment of the present invention.

FIG. 13 is another perspective view of the clip-on earphone according to the above second preferred embodiment of the present invention.

FIG. 14 is a sectional view of the clip-on earphone according to the above second preferred embodiment of the present invention.

FIG. 15 is an exploded view of the clip-on earphone according to the above second preferred embodiment of the present invention.

FIG. 16 is another exploded view of the clip-on earphone according to the above second preferred embodiment of the present invention.

FIG. 17 is a perspective view of a clip-on earphone according to a third preferred embodiment of the present invention.

FIG. 18 is an exploded view of the clip-on earphone according to the above third preferred embodiment of the present invention.

FIG. 19 is a perspective view of a clip-on earphone according to a fourth preferred embodiment of the present invention.

FIG. 20 is a perspective view of the clip-on earphone according to an alternative mode of the above fourth preferred embodiment of the present invention.

FIG. 21 is a perspective view of the clip-on earphone according to another alternative mode of the above fourth preferred embodiment of the present invention.

### DETAILED DESCRIPTION OF THE PREFERRED EMBODIMENT

The terms and phrases used in the following specification and claims are not limited to their literal meanings, but are only used by the inventors to enable a clear and consistent understanding of the present application. Therefore, the following description of various embodiments of the present application is provided for the purpose of illustration to those skilled in the art and is not intended to limit the scope of the present application as defined by the appended claims and their equivalents.

It should be understood that the term “a” or “an” should be understood as “at least one” or “one or more”, that is, in one embodiment, the quantity of a component can be one, while in another embodiment, the quantity of the component can be more than one. The term “a” or “an” should not be understood as limiting the quantity.

Although ordinal numbers such as “first”, “second”, etc. will be used to describe various components, it should not be construed as limiting those components. This term is only used to distinguish one component from another. For example, the first component can be referred to as the second component, and likewise, the second component can also be referred to as the first component, without departing from the teachings of the present application. The term “and/or” as used herein includes any and all combinations of one or more of the listed items.

The terms used herein are for the purpose of describing various embodiments and are not intended to be limiting. As used herein, the singular form is intended to include the plural form unless the context clearly indicates otherwise. Additionally, the terms “comprise” and/or “have” are understood to specify the presence of the features, numbers, steps, operations, components, elements, or combinations thereof as described in this specification, but do not exclude the presence or addition of one or more other features, numbers, steps, operations, components, elements, or combinations thereof.

In this application, a clip-on earphone 1 is adapted for being worn on the user's ear to receive signals emitted from an electronic device and convert the signals into audible sound for the user to hear, and may also be equipped with a microphone to receive commands from the user and convert the commands into telecommunication signals which is sent to a corresponding device for performing a related operation.

For the purpose of illustration, in this embodiment, a side of the clip-on earphone 1 that biasing against the user's ear during use is referred to as an inner side, and a side away from the user's ear is referred to as an outer side. An ear surface corresponding to the user's outer ear canal is referred to as a front ear side, and an ear surface facing the user's ear back is referred to as a rear ear side.

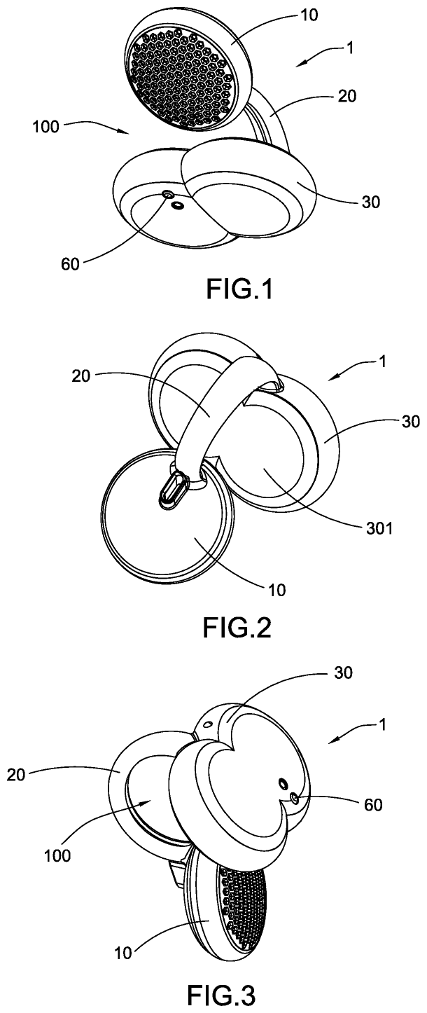

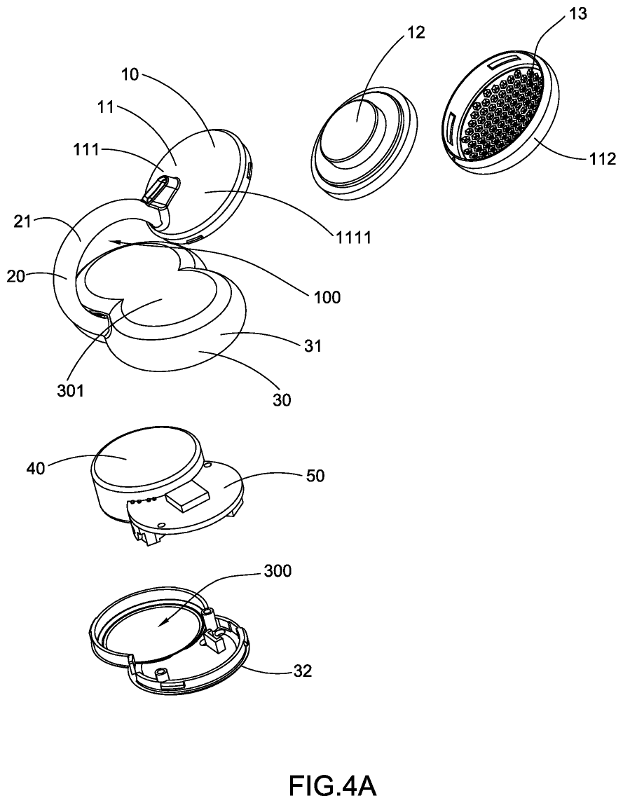

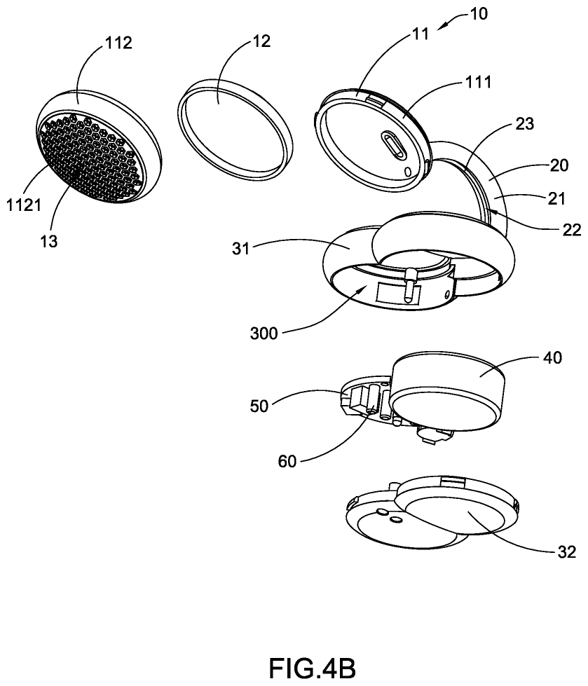

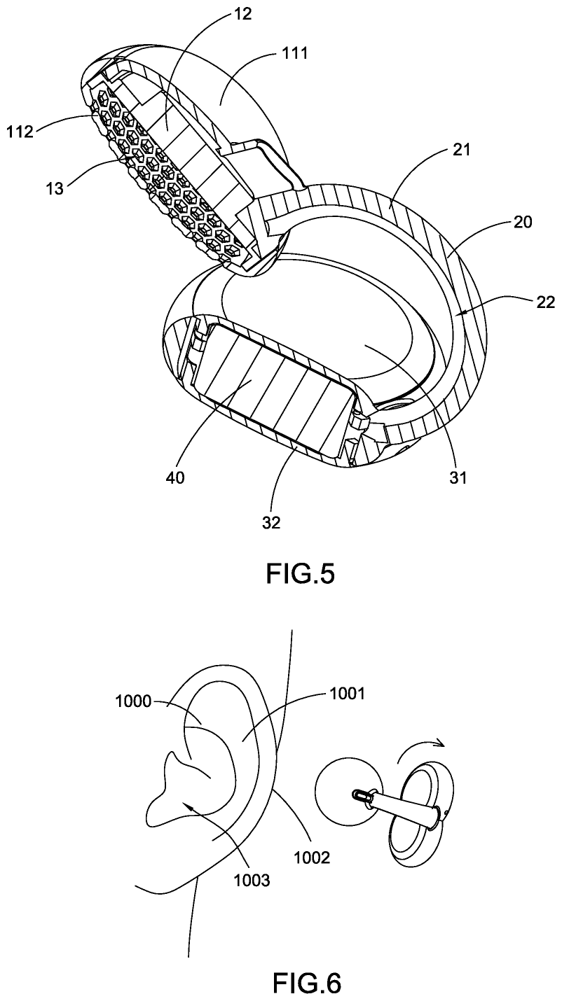

Referring to FIGS. 1 to 8 of the drawings of the present invention, a clip-on earphone 1 according to a first preferred embodiment of the present invention is illustrated. The clip-on earphone 1 comprises a cavum conchae wearing portion 10, a connecting portion 20, and a clamping portion 30, wherein the cavum conchae wearing portion 10 is connected to the clamping portion 30 through the connecting portion 20. In other words, one end of the connecting portion 20 is connected to the cavum conchae wearing portion 10, and the other end of the connecting portion 20 is connected to the clamping portion 30.

The cavum conchae wearing portion 10, the connecting portion 20, and the clamping portion 30 define a wearing space 100. When the clip-on earphone 1 is worn on the user's ear 1000, the cavum conchae wearing portion 10, the connecting portion 20, and the clamping portion 30 form the wearing space 100, so that the clip-on earphone 1 can be worn on the user's ear 1000 and around the auricle 1001. Preferably, the inner side of the clip-on earphone 1 is worn on the user's helix 1002 in a conforming manner, the cavum conchae wearing portion 10 is positioned in the cavum conchae 103 of the ear 1000 of the user, and the clamping portion 30 is located on the rear ear side of the ear and abuts against the back side of the auricle 1001. In other words, the connecting portion 20 is transversely crossing the user's helix 1002 to respectively arrange the cavum conchae wearing portion 10 and the clamping portion 30 on the front side and the back side of the user's ear 1000. Furthermore, the cavum conchae wearing portion 10 is located on the front side of the user's ear and adjacent to the user's outer ear canal, and the clamping portion 30 is located on the back side of the user's ear and conforms to the user's rear ear side, so that the clip-on earphone 1 can be securely clamped to the user's ear 1000 to make it difficult to fall off, even during vigorous movement of the user.

Specifically, the cavum conchae wearing portion 10 and the connecting portion 20 define a predetermined angle therebetween, and the clamping portion 30 and the connecting portion 20 also define a predetermined angle therebetween. The connecting portion 20 is curved and connects the cavum conchae wearing portion 10 with the clamping portion 30. The distance between the cavum conchae wearing portion 10 and the clamping portion 30 is smaller, the more stable when being worn on the ear 1000 by clamping. In other words, the clip-on earphone 1 is designed according to the structure of the human ear, conforming to ergonomic design, so that the clip-on earphone 1 can be better retained on the helix 1002 of the user, so as to avoid detachment during wearing and is not easily to be lost.

The cavum conchae wearing portion 10 is worn on the front ear side of the user's ear and is fitting to an opening of the outer ear canal to provide sound without sealing off the user's outer ear canal. Compared to in-ear headphones, the cavum conchae wearing portion 10 provides an open wearing manner, avoiding the direct insertion into the user's outer ear canal to block and seal the outer ear canal, as well as avoiding the breeding of bacteria, which can cause unhygienic conditions and lead to ear infections. In addition, it avoids direct insertion into the user's ear canal to completely block and seal the outer ear canal, preventing discomfort and even pain caused by pressure on the user's outer ear canal during long-term wearing, and avoids damage to the user's hearing ability. Furthermore, in some situations such as complex traffic conditions, the user can still hear external environment noise, thereby avoiding safety hazards.

Furthermore, the cavum conchae wearing portion 10 comprises an installation body 11, an acoustic unit 12, and at least one noise reduction hole 13. The acoustic unit 12 is disposed in the installation body 11. Accordingly, the installation body 11 has an installation space 110, and the acoustic unit 12 is installed in the installation space 110 of the installation body 11. The noise reduction hole 13 communicates the installation space 110 of the installation body 11 to outside, so as to avoid the acoustic unit 12 in the installation body 11 from generating unstable air pressure due to vibration, and thus physical noise reduction is provided. The acoustic unit 12 provides the function of sound output.

It can be understood that the acoustic unit 12 can be various speakers that can provide sound effects, such as moving coil speaker, moving iron speaker, planar diaphragm speaker, electrostatic diaphragm speaker, etc. Taking the moving coil speaker as an example, the acoustic unit 12 comprises corresponding components such as a bracket, a magnetic circuit system, a voice coil, and a diaphragm.

Furthermore, the Installation body 11 comprises an installation shell 111 and an installation cover 112 which is connected to the installation shell 111. The installation shell 111 and the installation cover 112 together form the installation space 110. The installation cover 112 has an installation end face 1121 facing the outer ear canal of the user's ear 1000. The acoustic unit 12 is arranged to face the installation end face 1121, transmitting vibrational sound effects to the user's eardrum inside the ear 1000.

The installation shell 111 is connected to the connecting portion 20. Preferably, the installation shell 111 is integrally connected to the connecting portion 20. The noise reduction hole 13 is formed in the installation cover 112, and the acoustic unit 12 is installed in the installation shell 111 or the installation cover 112 and located within the installation space 110. When the clip-on earphone 1 is worn, the installation shell 111 is exposed to the outside, and the installation cover 112 faces towards the opening of the user's outer ear canal and has multiple honeycomb-like small holes. Thus, the noise reduction hole 13 plays a role in physical noise reduction from the outside to the inside.

The clamping portion 30 comprises a clamping shell 31 and a clamping cover 32 which is connected to the clamping shell 31 to form an assembling space 300. The clamping shell 31 is connected to the connecting portion 20. Preferably, the clamping shell 31 is integrally connected to the connecting portion 20.

Furthermore, the installation shell 111, the connecting portion 20, and the clamping shell 31 are integrally formed from the same material. This allows the wearing space 100 of the clip-on earphone 1 to fit the auricle 1001, providing a more stable wearing experience. A sealed chamber is not formed between the cavum conchae wearing portion 10 of the clip-on earphone 1 and the eardrum of the wearer's ear 1000, so as to prevent impact damage to the eardrum. At the same time, it maintains good sound quality and does not block external environment noise, so that safety is ensured.

Furthermore, the installation shell 111, the connecting portion 20, and the clamping shell 31 are made of rigid or elastic materials. Preferably, the three components are integrally formed by a deformable material. For example, materials such as copper, silver, stainless steel, and precious metals like K gold and pure gold. In this embodiment, they are made of copper material to adjust the wearing space 100 of the clip-on earphone 1, thus adapting to different people's ears. In addition, being made of high-quality metal materials, it can resist daily wear and tear, prolonging the service life of the clip-on earphone 1. Additionally, the installation shell 111, the connecting portion 20, and the clamping shell 31 can also be made of materials such as ABS (acrylonitrile butadiene styrene) resin, PP (polypropylene) resin, PC (polycarbonate) resin, rubber, silicone, and other materials.

Specifically, as shown in FIG. 6, when the user first wears the clip-on earphone 1, if the user's helix 1002 is larger, the clip-on earphone 1 cannot be worn. The cavum conchae wearing portion 10 and the clamping portion 30 can be gently pulled in the opposite direction to expand the wearing space 100 of the clip-on earphone 1. When the user's helix 1002 is smaller and can be easily worn, at this time, the clip-on earphone 1 will be loose. The cavum conchae wearing portion 10 and the clamping portion 30 can be gently driven in the opposite direction, for example, by pinching the cavum conchae wearing portion 10 and the clamping portion 30 at both ends of the clip-on earphone 1 with the hand, thereby reducing the wearing space 100 of the clip-on earphone 1, making it firmly adhere to the auricle 1001 of the user's ear 1000 and making the inner surface of the clamping portion 30 closely fit to the helix 1002 of the user's ear 1000, that is, to attach to the edge skin of the ear 1000, so as to adapt to ears of different people. When it is necessary to remove the clip-on earphone 1 from the user's ear 1000, the user can apply sufficient downward pulling force with the hand to make the clip-on earphone 1 detach from the user's ear 1000.

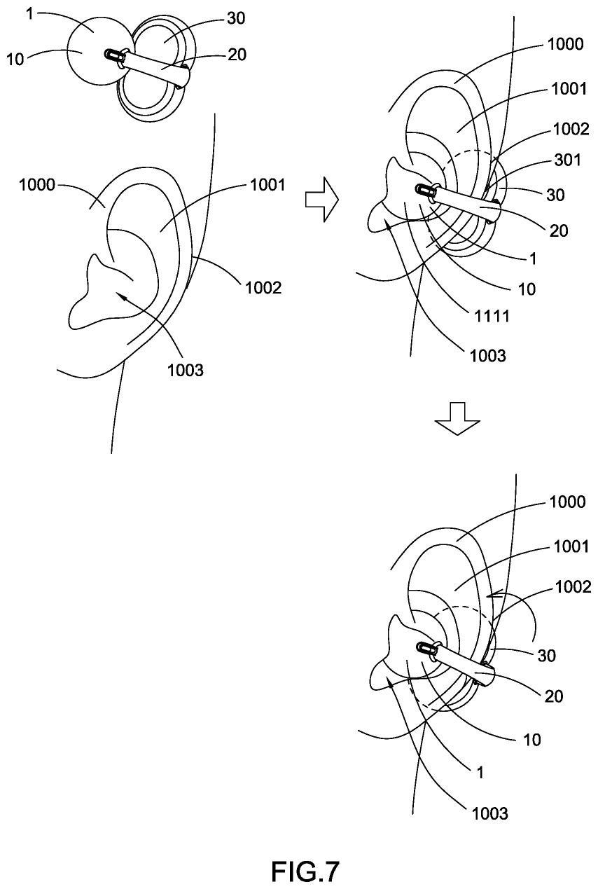

When the user first wears the clip-on earphone 1, as shown in FIG. 7, a sliding wearing method can also be used. Specifically, the user can hold the clip-on earphone 1 and align the wearing space 100 with the auricle 1001. Slide it from the upper edge of the auricle 1001 and reach a position that the cavum conchae wearing portion 10 is moved to the corresponding position of the cavum conchae 1003. The inner surface of the connecting portion 20 is fitted to the helix 1002. By pinching the cavum conchae wearing portion 10 and the clamping portion 30 of the clip-on earphone 1 with the hand, the wearing space 100 of the clip-on earphone 1 is reduced, so that the clip-on earphone 1 can fit tightly to the user's ear 1000 and clamp on the opposite sides of the auricle 1001. This wearing method utilizes the external shape of people's ears, by sliding along the auricle 1001 from top to bottom, it is possible to properly suspend the cavum conchae wearing portion 10 over the outer ear canal without completely inserting it into the outer ear canal to seal the outer ear canal. It will not leak sound and will not affect the reception of external environmental sounds, avoiding the formation of a closed cavity between the cavum conchae wearing portion 10 and the eardrum of the ear 1000, which may damage the hearing ability of the user.

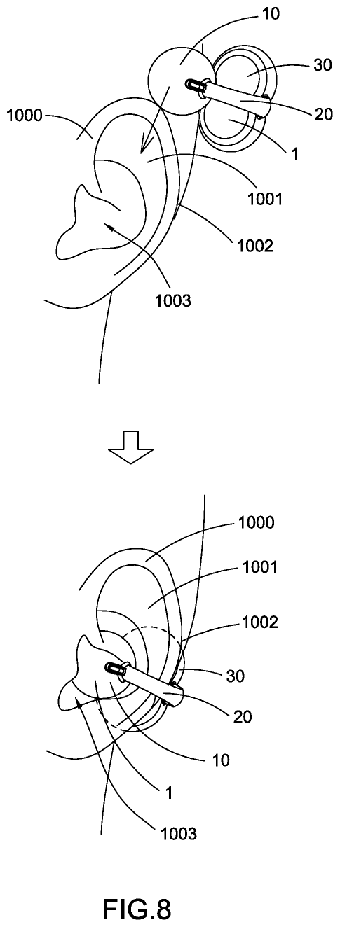

As shown in FIG. 8, when the clip-on earphone 1 is worn again, the user can hold the clip-on earphone 1 and align the wearing space 100 with the auricle 1001, sliding from the upper edge of the auricle 1001 and reaching the position that the cavum conchae wearing portion 10 is moved to the position corresponding to the cavum conchae 1003. The inner surface of the connecting portion 20 is fitted to the helix 1002, because the installation shell 111, the connecting portion 20, and the clamping shell 31 of the clip-on earphone 1 are integrally formed by a deformable material, so that after the first wearing, they can be deformed into the shape of the user's ear 1000, thus the clip-on earphone 1 can fit tightly to the user's ear 1000 and clamp on the opposite sides of the auricle 1001 when worn again.

When the installation shell 111, the connecting portion 20, and the clamping shell 31 are integrally formed from a rigid material, that is, when the wearing space 100 of the clip-on earphone 1 cannot be conveniently adjusted in size. The user also may use the external shape of the helix 1002 and the shape of the wearing space 100 of the clip-on earphone 1 to slide the clip-on earphone 1 from top to bottom around the user's ear 1000, and the cavum conchae wearing portion 10 fits the opening of the user's outer ear canal, and the clamping portion 30 fits against the user's ear back. That is, the connecting portion 20 spans and transversely extend across the user's helix 1002, and the cavum conchae wearing portion 10 and the clamping portion 30 are arranged on both sides of the user's auricle 1001, so as to find a suitable position to securely wear the clip-on earphone 1 on the user's ear 1000.

When the clip-on earphone 1 is worn on the user's ear 1000, in this embodiment of the present invention, the cavum conchae wearing portion 10 is placed in the position of the cavum conchae 1003 of the ear 1000. The installation end face 1121 of the installation cover 112 of the installation body 11 of the cavum conchae wearing portion 10 is located on the inner side and faces the outer ear canal of the ear 1000, and the outer surface 1111 of the installation shell 111 of the installation body 11 of the cavum conchae wearing portion 10 is located on the outer side. The inner surface 201 of the connecting portion 20 is wrapped around the user's auricle 1001, and the inner surface 201 further fits against the helix 1002. The clamping portion 30 is located on the rear ear side of the ear 1000 and its inner surface 301 fits against the back side of the auricle 1001 of the ear 1000. Due to the clamping action of the clamping portion 30 and the connecting portion 20, the cavum conchae wearing portion 10 does not need to be completely inserted into the outer ear canal like a conventional earphone which requires to completely seal off the outer ear canal. The clip-on earphone 1 of the present invention allows the user to wear it for a long time without resulting in the hearing disorder of the user.

The cavum conchae wearing portion 10 and the clamping portion 30 are connected by the connecting portion 20, and the installation end face 1121 of the installation cover 112 of the installation body 11 of the cavum conchae wearing portion 10 is kept at a predetermined angle with the inner surface 301 of the rear ear side of the ear 1000 by the clamping portion 30 to conform to the ergonomic shape of the human ear. When the inner surface of the cavum conchae wearing portion 10, that is, the installation end face 1121 of the installation cover 112 of the installation body 11, is kept at a vertical direction, the inner surface 301 of the clamping portion 30 is in an inclined state with the rear ear side of the ear 1000. There is a predetermined angle between the two planes, for example, 15 to 75 degrees, preferably 30 to 60 degrees.

It is worth noting that the installation cover 112 of the installation body 11 of the cavum conchae wearing portion 10 and the clamping cover 32 may be made of a material different from the material of the installation shell 111, the connecting portion 20 and the clamping shell 31. For example, the installation cover 112 is made of a plastic material and the clamping cover 32 is made of material with strong transmittance, thereby avoiding signal shielding and weakening signal reception and transmission, so that the user can obtain a better wearing and audible hearing experience. As an example, the clamping cover 32 is made of a material such as plastic, ABS, and silicone gel.

The clip-on earphone 1 further comprises a power unit 40, a control panel 50, and at least one control button 60. The power unit 40 and the control panel 50 are electrically connected and can be installed in a clamping portion installation space 300. The control button 60 is installed on the outer surface of the clamping cover 32. It can be understood that either the control panel 50 or the power unit 40 can also be installed in the cavum conchae wearing portion 10. Preferably, both the control panel 50 and the power unit 40 are disposed in the assembling space 300 of the clamping part 30, and only the acoustic unit 12 is set in the cavum conchae wearing portion 10. Therefore, the space inside the cavum conchae wearing portion 10 is used to accommodate the acoustic unit 12, allowing for a larger size of the acoustic unit 12 and thus providing better sound quality.

It is worth mentioning that the connecting portion 20 comprises a connecting body 21 and a wire groove 22. In this embodiment, the connecting body 21 is implemented as a connecting rod, and the wire groove 22 is disposed along an inner surface of the connecting portion 20 on the side facing the wearing space 100 of the clip-on earphone 1. It can be understood that in other embodiments, the wire groove 22 can also be located on an outer surface of the connecting portion 20 at the side away from the wearing space 100 of the clip-on earphone 1.

The connecting portion 20 further comprises a set of power cords 23, which are arranged in the wire groove 22, so as to electrically connect the acoustic unit 12 to the control panel 50, thereby allowing the control panel 50 to transmit audio signals to the acoustic unit 12.

By setting the wire groove 22 on the surface of the connecting portion 20, the installation shell 111, the connecting portion 20, and the clamping shell 31 can be easily processed and formed together. In addition, when the wire groove 22 is located on the outer surface of the connecting portion 20, the power cords 23 can be exposed, so that the clip-on earphone 1 can be decorated by choosing suitable colors of the power cords 23 to match with the connecting portion 20.

Alternatively, the wire groove 22 can also be set inside the connecting portion 20, that is, the connecting portion 20 is formed with a hollow channel. The power cords 23 pass through the hollow channel of the connecting portion 20. As a result, the power cords 23 are hidden inside the connecting portion 20 without affecting the external beauty of the clip-on earphone 1.

In this embodiment, the wire groove 22 is implemented as an elongated groove formed along the inner surface of the connecting portion 20. When the clip-on earphone 1 is worn on the user's ear, the power cord 23 and the wire groove 22 are hidden. That is, the power cord 23 and the wire groove 22 cannot be seen from the outside, thus not affecting the overall external beauty of the clip-on earphone 1. In addition, compared to the structure of setting the wire groove 22 inside the connecting portion 20, it saves production processes more effectively and is more convenient to assemble the power cords 23.

The power unit 40, the control panel 50, and the control button 60 are electrically connected to each other. When the user is using the clip-on earphone 1, volume adjustment, channel switching, power on/off, answering calls, and other operations can be achieved by touching or pressing the control button 60. Specifically, different adjustments can be controlled by the pressing time and frequency of the control button 60. By pressing the control button 60, the wearer transmits a signal to the control panel 50, which is then processed and issued instructions by a signal processing unit, thereby achieving different functional adjustments.

It can be understood that in another alternative embodiment, the power unit 40 is installed in the installation space 110, that is, the power unit 40 and the acoustic unit 12 are installed in the installation space 110. The the control panel 50 can also be installed in the assembling space 300. That is, the power unit 40 and the the control panel 50 are installed in the assembling space 300. The control button 60 can also be set on the outer surface of the installation body 11 or on the outer surface of the connecting portion 20. When the clip-on earphone 1 is in use, the control button 60 faces outward, making it convenient for the user to touch or press.

In this embodiment, the power unit 40 is implemented as a rechargeable battery. It can be repeatedly charged to provide electrical energy for repeated use. In addition, in this embodiment, the cross-section of the clamping portion 30 can be two connected semicircles, and the assembling space 300 forms two sub-cavities to accommodate the power unit 40 and the control panel 50 side by side.

It can be understood that the control panel of the clip-on earphone 1 can further incorporate with a communication module and a microphone. Among them, the microphone is used to collect the user's voice commands and deliver them to the communication module. The control panel 50 further incorporate an intelligent analysis modules such as an artificial intelligence module, so as to achieve voice intelligent interaction. For example, the communication module transmits control signals to smart home appliances, new energy vehicles, electronic devices, etc., to complete the operation of corresponding smart home appliances, new energy vehicles, electronic devices.

For example, the clip-on earphone 1 can be used as a terminal device for smart voice interaction. When the user wears the clip-on earphone 1 while driving a new energy vehicle, the user of the clip-on earphone 1 issues a voice command “turn on the air conditioning” to the clip-on earphone 1. After the communication module receives the user's command, it transmits the command “turn on the air conditioning” to the vehicle's sensing system. The vehicle automatically turns on the air conditioning after receiving the signal transmitted by the communication module. The user of the clip-on earphone 1 issues a voice command “turn on the navigation” to the clip-on earphone 1. After the communication module receives the user's command, it transmits the command “turn on the navigation” to the vehicle's sensing system. The vehicle automatically turns on the navigation system of the vehicle's electronic device and further completes the navigation task to the destination according to the user's command. It can be understood that the voice interaction here is only an example. The clip-on earphone 1 can also be more widely used in various intelligent interaction scenarios for controlling smart home appliances, smart office appliances, smart calls, smart driving, smart healthcare, and other aspects of life and work.

That is to say, the clip-on earphone 1 of the present invention can be worn for a long time without pain or discomfort, and can avoid hearing disorder. Therefore, the clip-on earphone 1 can be worn on the user's ear 1000 for a long time as an artificial intelligence assistant device. It can obtain instructions in real time through audio commands of the user, recognize and process collected information, provide feedback based on semantic results, and finally perform corresponding intelligent control tasks.

It is worth mentioning that the microphone can be built-in with an algorithm to have noise reduction effect. That is, when the microphone receives the user's voice commands, it can reduce the noise in the environment, so that the microphone can obtain a purer user's voice.

The clip-on earphone 1 can be equipped with other intelligent sensors, such as an optical heart rate sensor. The optical heart rate sensor is installed in the assembling space 300 or the installation space 110, and is set on the inner side of the clip-on earphone 1, that is, the side close to the user's ear. The light reflected back through the skin tissue is received by the optical heart rate sensor and converted into an electrical signal, which is then converted into a sound signal and finally broadcasted to the user through the acoustic unit 12, so as to measure the wearer's heart rate.

The clip-on earphone 1 can also comprise a temperature sensor, wherein the temperature sensor is installed inside the assembling space 300 or the installation space 110, and is positioned on the inner side of the clip-on earphone 1, i.e., the side close to the user's ear. The temperature sensor receives and converts the body temperature emitted by the skin tissue into an audio signal, and finally broadcasts it to the user through the acoustic unit 12, thereby measuring the wearer's body temperature.

It should be noted that in order to balance the weight of the clip-on earphone 1, the cavum conchae wearing portion 10 and the clamping portion 30 located on both sides of the user's auricle can be configured to have a similar weight, thereby avoiding discomfort for the user due to uneven weight on both sides of the auricle when wearing the clip-on earphone 1.

It is worth mentioning that the total weight of the clip-on earphone 1 is small, for example, it can be controlled within 16 g, so that the user feels no pressure and no weight when wearing it, avoiding discomfort caused by weight during long-term wearing.

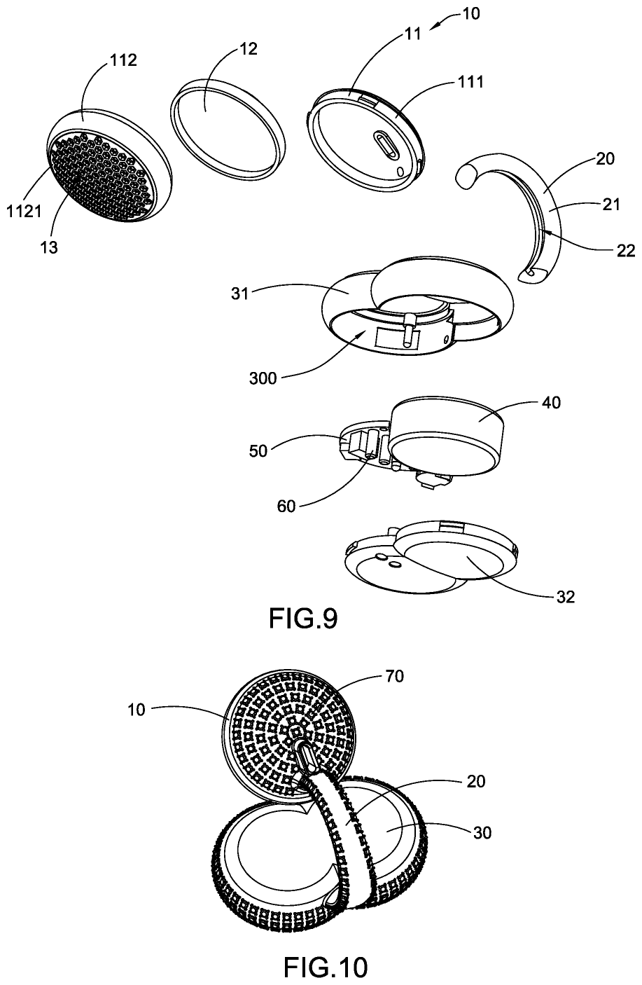

Referring to FIG. 9 of the drawings of the present invention, a clip-on earphone 1 according to an alternative mode of the first preferred embodiment of the present invention is illustrated. The clip-on earphone 1 comprises the cavum conchae wearing portion 10, the connecting portion 20, and the clamping portion 30. The cavum conchae wearing portion 10 is connected to the clamping portion 30 through the connecting portion 20. That is, one end of the connecting portion 20 is connected to the cavum conchae wearing portion 10, and the other end is connected to the clamping portion 30.

In this embodiment, the connecting portion 20, the cavum conchae wearing portion 10, and the clamping portion 30 can be made of different materials. More specifically, the connecting portion 20 is made of a flexible material, while the installation shell 111 of the cavum conchae wearing portion 10 and the clamping shell 31 of the clamping portion 30 can be made of a rigid material. After the assembly and welding of the connecting portion 20, the cavum conchae wearing portion 10, and the clamping portion 30, the connecting portion 20 allows for a predetermined deformation, while the cavum conchae wearing portion 10 and the clamping portion 30 can maintain a fixed shape without deformation. When the user wears the clip-on earphone 1, by pressing or pulling the cavum conchae wearing portion 10 and the clamping portion 30, the cavum conchae wearing portion 10 and the clamping portion 30 can drive the connecting portion 20 to generate the required deformation, thereby adjusting the size of the wearing space.

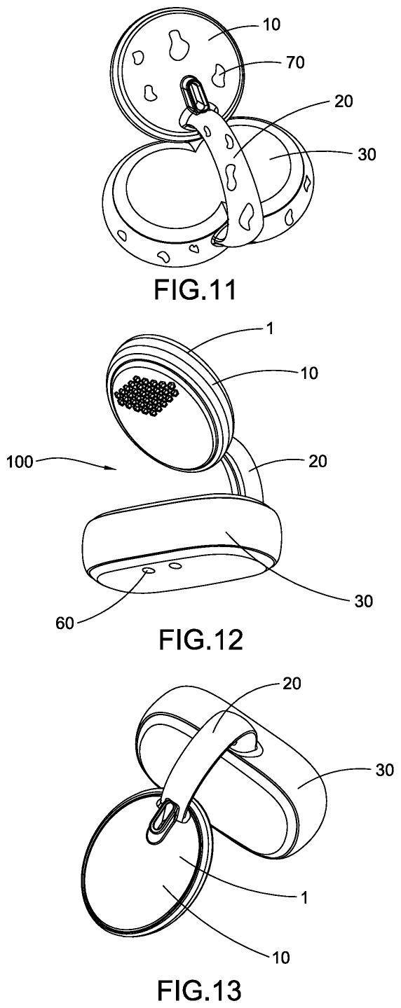

As shown in FIGS. 10 and 11, according to another alternative mode, the clip-on earphone 1 may also be equipped with one or more decorative elements 70, which can be set on at least a portion of the cavum conchae wearing portion 10, the connecting portion 20, and the clamping portion 30. For example, the installation shell 111, the connecting portion 20, and the clamping shell 31 of the clip-on earphone 1 are formed by integral molding of deformable copper. Based on this, multiple diamonds can be assembled on the surface of the copper, as shown in FIG. 10, or different patterns can be carved on the surface of the copper, as shown in FIG. 11, so as to enhance the external beauty of the clip-on earphone 1 and provide a decorative effect. In comparison to the conventional plastic shell earphones, the use of diamond inlay and pattern carving techniques gives the clip-on earphone 1 a unique appearance and meets the aesthetic needs of beauty lovers.

It can be understood that the decorative element 70 can also be set on at least a portion of the surface of the clip-on earphone 1 in other ways, such as being assembled on the installation shell 111 of the clip-on earphone 1 through screwing, buckling, magnetic attraction, etc., and on at least a portion of the surface of the connecting portion 20 and the clamping shell 31. At least a portion of the cavum conchae wearing portion 10, the connecting portion 20, and the clamping portion 30 can also be processed with surface treatment techniques such as sandblasting to create decorative patterns.

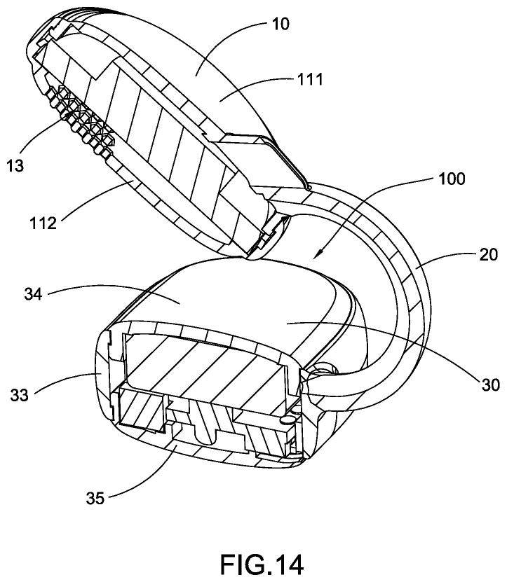

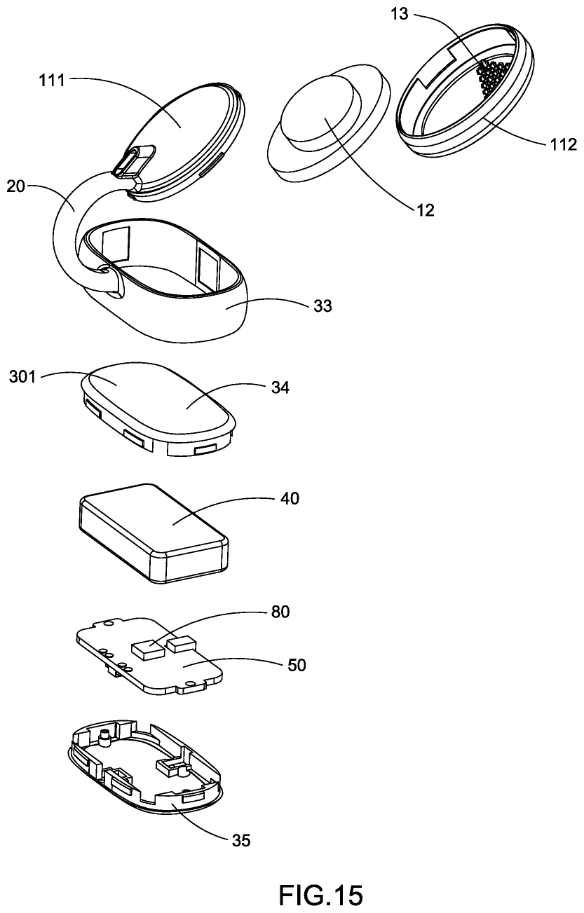

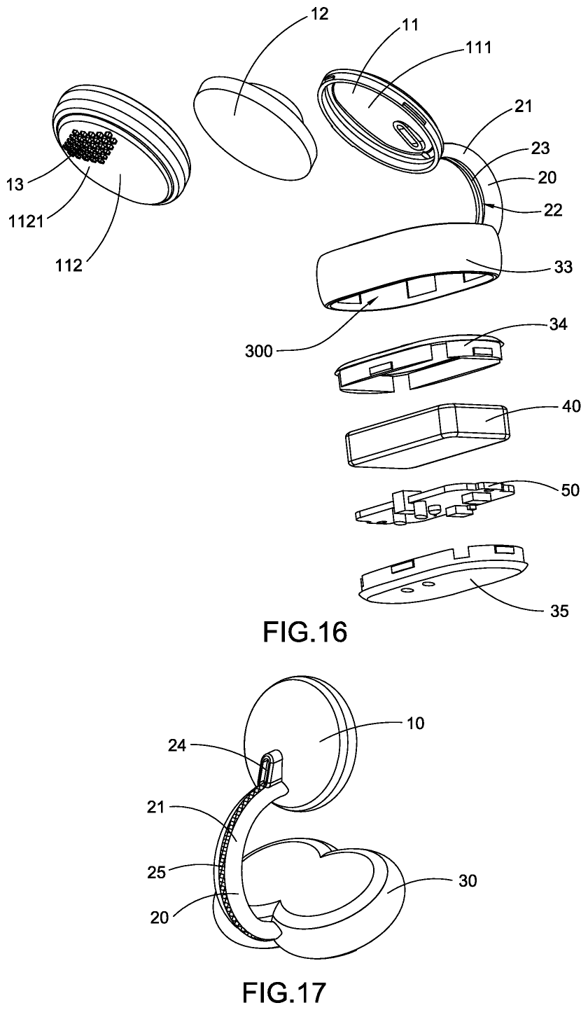

Referring to FIGS. 12 to 16 of the drawings of the present invention, the clip-on earphone 1 according to a second preferred embodiment of the present invention is illustrated. The clip-on earphone 1 comprises the cavum conchae wearing portion 10, the connecting portion 20, and the clamping portion 30, and the cavum conchae wearing portion 10 is connected to the clamping portion 30 through the connecting portion 20. That is to say, one end of the connecting portion 20 is connected to the cavum conchae wearing portion 10, and the other end is connected to the clamping portion 30.

Similarly, the cavum conchae wearing portion 10 comprises an installation body 11, an acoustic unit 12, and has at least one noise reduction hole 13. The acoustic unit 12 is disposed in the installation body 11. Accordingly, the installation body 11 has an installation space 110, and the acoustic unit 12 is installed in the installation space 110 of the installation body 11. The noise reduction hole 13 is communicating the installation space 110 of the installation body 11 to outside, so as to avoid the pressure instability caused by vibration in the acoustic unit 12 inside the installation body 11 and provide physical noise reduction. The acoustic unit 12 provides the function of sound output.

The installation body 11 comprises an installation shell 111 and an installation cover 112 which is connected to the installation shell 111. The installation shell 111 and the installation cover 112 define the installation space 110. The installation cover 112 has an installation end face 1121, which faces the external auditory canal of the user's ear 1000. The acoustic unit 12 is arranged to face the installation end face 1121, so as to transmit the vibrational sound effect to the user's eardrum inside the ear 1000.

The installation shell 111 is connected to the connecting portion 20. Preferably, the installation shell 111 is integrally connected to the connecting portion 20. The noise reduction hole 13 is formed in the front shell 112, and the acoustic unit 12 is installed in the installation shell 111 or the installation cover 112 and located within the installation space 110. When the clip-on earphone 1 is worn, the installation shell 111 is exposed to the outside, and the installation cover 112 is fitted to the user's outer ear canal and has multiple cellular-shaped small holes. Therefore, the noise reduction hole 13 plays a role in physically reducing noise from the outside to the inside.

The clamping portion 30 in this embodiment comprises a middle frame 33, an inner cover 34, and an outer cover 35. The inner cover 34 and the outer cover 35 are connected to opposite sides of the middle frame 33 to form an assembling space 300. The middle frame 33 is connected to the connecting portion 20. Preferably, the middle frame 33 is integrally connected to the connecting portion 20.

Furthermore, the installation shell 111, the connecting portion 20, and the middle frame 33 are integrally formed from the same material. This allows the clip-on earphone 1 to maintain the wearing space 100 in accordance with the shape of the human ear canal 1001, providing a more stable wearing experience. The cavum conchae wearing portion 10 of the clip-on earphone 1 and the eardrum the wearer's ear 1000 do not form a sealed chamber therebetween, so as to prevent impact damage to the eardrum. At the same time, it maintains good sound quality and does not block external environment noise, so that safety is ensured.

Furthermore, the installation shell 111, the connecting portion 20, and the middle frame 33 are made of rigid or elastic materials. Preferably, they are integrally formed by a deformable material. For example, materials such as copper, silver, stainless steel, and precious metals like K gold and pure gold. In this embodiment, they are made of copper. The deformation of the copper material allows for adjustment of the wearing space 100 of the clip-on earphone 1, making it suitable for different individuals. Additionally, being made of high-quality metal materials, it can resist daily wear and tear, thus prolonging the service life of the clip-on earphone 1. Moreover, the installation shell 111, the connecting portion 20, and the middle frame 33 can also be made of materials such as ABS, PP, PC, rubber, silicone, and the like.

The clip-on earphone 1 further comprises a power unit 40, a control panel 50, and at least one control button 60. The power unit 40 and the control panel 50 are electrically connected and can be installed in the assembling space 300. The control button 60 is located on the outer surface of the clamping cover 32. In this embodiment, the power unit 40 and the control panel 50 can be stacked and overlapped inside the assembling space 300, which is different from the side-by-side arrangement in the above embodiment.

Similarly, the connecting portion 20 comprises a connecting body 21 and has a wire groove 22. In this embodiment, the connecting body 21 is implemented as a connecting rod, and the wire groove 22 is formed along the inner surface of the connecting portion 20 located at the inner side of the clip-on earphone 1. The connecting portion 20 further comprises a set of power cords 23 which is arranged in the wire groove 22 to electrically connect the acoustic unit 12 to the control panel 50, allowing the control panel 50 to transmit audio signals to the acoustic unit 12.

In this embodiment, the control panel 50 also may be incorporated with a hearing aid unit 80 which is set inside the clamping portion 30 and comprises structures such as a microphone, amplifier, and receiver. The microphone is used to collect sound and convert it into electrical waves, the amplifier is used to increase the intensity of the electrical waves, and the receiver is used to convert the electrical energy back into sound waves. The hearing aid unit 80 has the function of assisting users in auditory recovery. The control panel 50 coordinates the output relationship between the hearing aid unit 80 and the acoustic unit 12 during the wearing process of the clip-on earphone 1.

Specifically, the clip-on earphone 1 combines the hearing-aid and the earphone together, that is to say, the clip-on earphone 1 centralizes the sound output and hearing assistance functions. In other words, the clip-on earphone 1 can both make phone calls and assist the user in hearing conversations, and it can switch autonomously between the two scenarios. When there is an incoming call, the control panel 50 processes the signal and connects to the mobile phone via Bluetooth, switching to the phone call function. Normally, it can be used as a hearing aid, making it convenient for users with poor hearing, avoiding the phenomenon of insufficient space caused by the simultaneous use of earphones and hearing aids in the ear canal, and avoiding a series of troubles.

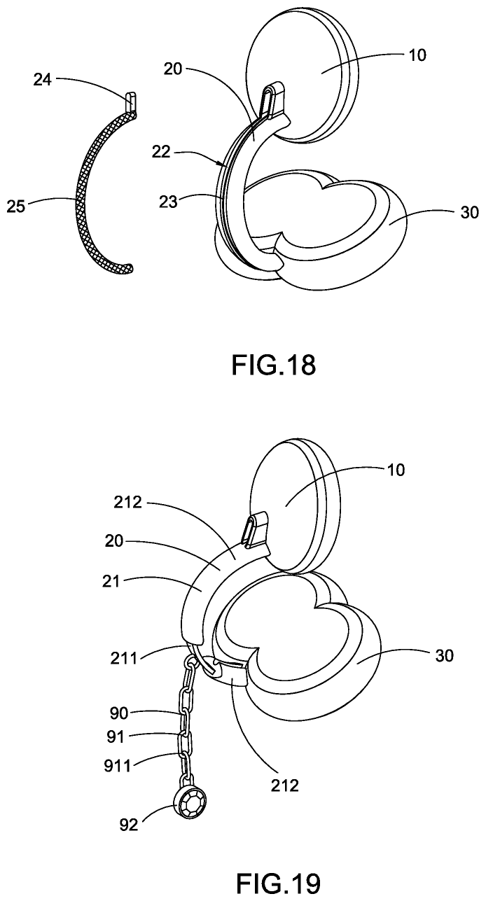

Referring to FIGS. 17 to 18 of the drawings of the present invention, the clip-on earphone 1 according to a third preferred embodiment of the present invention is illustrated. The clip-on earphone 1 comprises the cavum conchae wearing portion 10, the connecting portion 20, and the clamping portion 30. The cavum conchae wearing portion 10 is connected to the clamping portion 30 through the curved connecting portion 20. In other words, one end of the connecting portion 20 is connected to the cavum conchae wearing portion 10, and the other end is connected to the clamping portion 30.

In this embodiment, the connecting portion 20 comprises a connecting body 21 and has a wire groove 22. In this embodiment, the connecting body 21 is implemented as a connecting rod, and the wire groove 22 is extended along an outer surface of the connecting portion 20 located at an outer side of the clip-on earphone 1. The connecting portion 20 further comprises a set of power cords 23 which is arranged in the wire groove 22, thereby electrically connecting the acoustic unit 12 to the control panel 50, allowing the control panel 50 to transmit audio signals to the acoustic unit 12.

The connecting portion 20 further comprises a light emitting element 24 and a light guiding element 25 such as a light guide fiber. The light emitting element 24 is located at one end of the connecting body 21, and the light guide element 25 is located in the wire groove 22. When the light emitting element 24 emits light, its light can be guided into the light guiding element 25, thereby forming a light strip in the connecting portion 20 to enhance the cool lighting effect of the clip-on earphone 1. The power cord 23 can be built-in the light guide element 25 or can be set in the wire groove 22 and located at the bottom side of the light guiding element 25.

Referring to FIG. 19 of the drawings of the present invention, the clip-on earphone 1 according to a fourth preferred embodiment of the present invention is illustrated. The clip-on earphone 1 comprises the cavum conchae wearing portion 10, the connecting portion 20, and the clamping portion 30. The cavum conchae wearing portion 10 is connected to the clamping portion 30 through the arc-shaped connecting portion 20. That is to say, one end of the connecting portion 20 is connected to the cavum conchae wearing portion 10, and the other end is connected to the clamping portion 30.

In this embodiment, the connecting portion 20 comprises a connecting body 21, which can be made of the aforementioned metal material. The connecting body 21 includes a central section 211 and two connecting sections 212. The central section 211 is located between the two connecting sections 212, and has a smaller thickness compared to the two connecting sections 212. As a result, the cavum conchae wearing portion 10 and the clamping portion 30 can be pinched inward or pulled outward with the central section 211 of the connecting body 21 as a pivot point to adjust their positions, thereby adjusting the size of the wearing space 100 formed by the cavum conchae wearing portion 10, the connecting portion 20, and the clamping portion 30, so that the clip-on earphone 1 can fit the ears 1000 of different users

In addition, the clip-on earphone 1 may also comprise a pendant element 90 which comprises a hanging string 91 and a pendant 92. One end of the hanging string 91 is connected to the connecting body 21 of the connecting portion 20, and the other end thereof is connected to the pendant 92. The hanging string 91 can be a rope or strap, which can be made of the same material as the connecting body 21 and connected integrally, such as by welding. For example, the hanging string 91 can also be made of materials such as copper, silver, stainless steel, and precious metals like K gold and pure gold. For example, in the example shown in the figures, the hanging string 91 comprise multiple interconnected rings 911. The pendant 92 has a predetermined decorative pattern, such as heart-shaped, circular, star-shaped, and various other shapes, and its material can also be copper, silver, stainless steel, and precious metals like K gold and pure gold. In other words, the pendant element 90 enhances the decorative effect of the clip-on earphone 1. The pendant element 90 can also be further processed through diamond inlay and pattern carving techniques to give the clip-on earphone 1 a unique and aesthetically pleasing decorative effect.

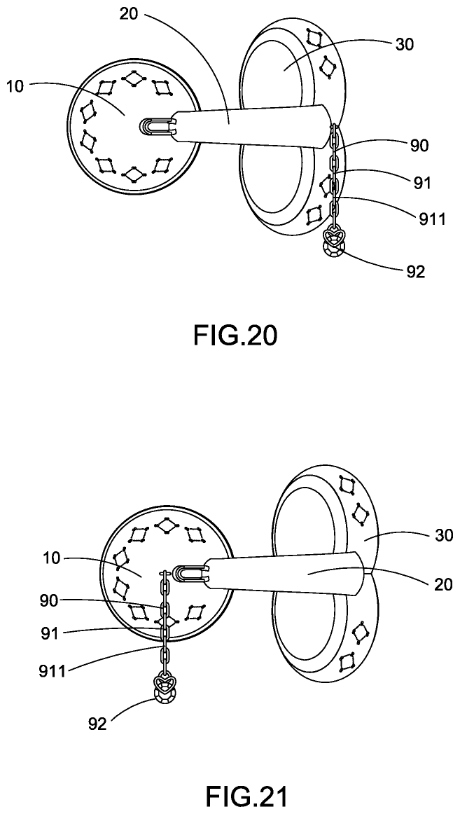

It can be understood that when the user wears the clip-on earphone 1 on the ear 1000, the pendant element 90 is preferably suspended on the front or the lateral side of the ear 1000, so that the pendant element 90 can be conveniently and clearly seen by the user from the front. In addition, in another embodiment, as shown in FIG. 20 of the drawings, the hanging string 91 of the pendant element 90 can also be connected to the clamping portion 30. When the user wears the clip-on earphone 1 on the ear 1000, the pendant element 90 hangs down from the back of the ear 1000. Of course, the hanging string 91 of the pendant element 90 can also be connected to the cavum conchae wearing portion 10, as shown in FIG. 21 of the drawings. When the user wears the clip-on earphone 1 on the ear 1000, the pendant element 90 hangs down from the position of the ear canal 1003 on the front side of the ear 1000.

The above description of specific embodiments has illustrated the basic principles of the present application. However, it should be noted that the advantages, benefits, effects, etc. mentioned in this application are only examples and not limitations, and it should not be assumed that these advantages, benefits, effects, etc. must be present in all embodiments of the present application. In addition, the specific details disclosed above are for illustrative and explanatory purposes, and not limitations. These details do not limit the implementation of the present application to the specific details disclosed. The functional and structural principles of the present application have been demonstrated and described in the embodiments, and without departing from these principles, the embodiments of the present invention can be modified or altered in any way.

What is claimed is:

1. A clip-on earphone, comprising:
a cavum conchae wearing portion which is adapted to be worn at a cavum conchae of an ear of a user;
a connecting portion which is adapted to surround the user's helix; and
a clamping portion which is adapted to fit on a rear ear side of said user's ear, wherein said cavum conchae wearing portion is connected to said clamping portion through said connecting portion and forms a wearing space, and at least a portion of the user's helix is adapted to be clamped in said wearing space.

2. The clip-on earphone according to claim 1, wherein said clip-on earphone is worn on the user, an inner side of said connecting portion is configured to span and fit on the user's helix.

3. The clip-on earphone according to claim 1, wherein when said clip-on earphone is worn on the user, said cavum conchae wearing portion and said clamping portion are configured to be adjustable relative to each other to fit the user's auricle.

4. The clip-on earphone according to claim 1, wherein said connecting portion is integrally connected with said cavum conchae wearing portion and said clamping portion, wherein said clamping portion, and at least a portion of said connecting portion and at least a portion of said cavum conchae wearing portion which are connected to said connecting portion are deformable, so as to facilitate adjustment of said wearing space.

5. The clip-on earphone according to claim 4, wherein a material of said clamping portion, and said portion of said connecting portion and said portion of said cavum conchae wearing portion which are connected to said connecting portion is copper, silver, stainless steel, or precious metal.

6. The clip-on earphone according to claim 1, wherein said connecting portion is assembled with said cavum conchae wearing portion and said clamping portion, wherein said connecting portion is deformable, and said cavum conchae wearing portion and said clamping portion are deformable or rigid.

7. The clip-on earphone according to claim 1, wherein said cavum conchae wearing portion comprises an installation body having an installation space, and an acoustic unit is installed in said installation space of said installation body and is suitable for facing an outer ear canal of the user's ear.

8. The clip-on earphone according to claim 7, wherein said installation body of said cavum conchae wearing portion comprises an installation shell and an installation cover, and said clamping portion comprises a clamping shell and a clamping cover, wherein said connecting portion is connected to said installation shell and said clamping shell, wherein said connecting portion, said installation shell, and said clamping shell are made of a deformable material.

9. The clip-on earphone according to claim 1, wherein said installation body of said cavum conchae wearing portion comprises an installation shell and an installation cover, said installation cover is suitable for facing an outer ear canal of the user, wherein said clamping portion comprises a middle frame, an inner cover, and an outer cover, wherein said inner cover and said outer cover are connected to opposite sides of said middle frame, wherein said connecting portion, said installation shell, and said middle frame are integrated and made of a deformable material.

10. The clip-on earphone according to claim 1, further comprising one or more decorative elements arranged on at least a portion of a surface of said cavum conchae wearing portion, said connecting portion, and said clamping portion.

11. The clip-on earphone according to claim 1, further comprising a power unit and a control panel, and at least one of said power unit and said control panel is installed in said clamping portion.

12. The clip-on earphone according to claim 11, further comprising a hearing aid module which is electrically connected to said control panel to integrate functions of a hearing-aid and an earphone.

13. The clip-on earphone according to claim 11, wherein said control panel is integrated with a microphone and an artificial intelligence module to enable said clip-on earphone to form a smart voice interaction assistant.

14. The clip-on earphone according to claim 1, wherein said connecting portion comprises a connecting body and has a wire groove, wherein said said clip-on earphone comprises a set of pow cords disposed in said wire groove which is recessed on an outer surface or an inner surface of said connecting body.

15. The clip-on earphone according to claim 1, wherein when said clip-on earphone is worn on the user, said cavum conchae wearing portion faces an outer ear canal at an inner side, and an inner side of said clamping portion is inclinedly abutted against the rear ear side of the user's ear.

16. The clip-on earphone according to claim 1, further comprising a pendant element which comprises a hanging string and a pendant, wherein one end of said hanging string is connected to one of said cavum conchae wearing portion, said connecting portion, and said clamping portion, and the other end of said hanging string is connected to said pendant.

17. The clip-on earphone according to claim 14, wherein said connecting portion further comprises a light emitting element and a light guiding element, wherein said light emitting element is disposed at one end of said connecting body, and said light guiding element is disposed in said wire groove, and when said light emitting element emits light, said light is guided into said light guiding element.

18. The clip-on earphone according to claim 1, wherein said connecting portion comprises a connecting body, said connecting body comprises a central section and two connecting sections, wherein said central section is located between said two connecting sections, and said central section has a smaller thickness compared to said two connecting sections.

19. A method for wearing a clip-on earphone, comprising the following steps:
(a) configuring relative position of a cavum conchae wearing portion and a clamping portion to be adjustable so that a wearing space formed by said cavum conchae wearing portion, said clamping portion, and a connecting portion is capable of being adjusted; and
(b) configuring said cavum conchae wearing portion adapted to be worn at a cavum conchae and said clamping portion adapted to be fitted on a rear ear side of the user's ear to clamp at least a portion of the user's helix in said wearing space, so that said cavum conchae wearing portion and said clamping portion are constructed to be clamped on two sides of the user's auricle.

20. A method for wearing a clip-on earphone, comprising the following steps:
(A) configuring a wearing space formed by a cavum conchae wearing portion, a clamping portion, and a connecting portion which is adapted to be aligned with a user's helix and allowing the clip-on earphone to slide down along the helix from an upper edge of the user's helix; and
(B) configuring said cavum conchae wearing portion adapted to be slid down to be worn at a cavum conchae and said clamping portion adapted to be slid down to be fitted on a rear ear side of the user's ear to clamp at least a portion of the user's helix in said wearing space, so that said cavum conchae wearing portion and said clamping portion are constructed to be clamped on two sides of the user's auricle.
